(19) United States
(12) Patent Application Publication
(10) Pub. No.: US 2015/0021274 A1
(43) Pub. Date: Jan. 22, 2015

(54) HYPERBRANCHED POLYMERS

(71) Applicant: DSM IP Assets B.V., Heerlen (NL)

(72) Inventors: Henricus Johannes Arts, Echt (NL); Franciscus Johannes Marie Derks, Echt (NL); Wendy Hyett, Echt (NL); Stijn Witters, Echt (NL)

(21) Appl. No.: 14/366,549

(22) PCT Filed: Dec. 20, 2012
(86) PCT No.: PCT/EP2012/076286

§ 371 Date: Jun. 18, 2014

(30) Foreign Application Priority Data
Dec. 20, 2011 (EP) 11194576.2

(51) Int. Cl. C08G 69/44; C02F 1/56; C08G 63/685

(52) U.S. Cl. CPC C08G 69/44; C08G 63/6854; C02F 1/56; C02F 2305/00
USPC 210/735; 525/437; 528/288; 252/60

(57) ABSTRACT

There is disclosed certain hyperbranched polyester amides with a cloud point of at least 50° C. in water with end groups selected from: two or more i] tertiary amine functional end groups ii) ammonium functional end groups, iii) polyalkylene glycol functional end groups; iv) quaternary ammonium zwitterionic end groups and/or v) other ionic groups (such as phosphate or sulfate), that are useful in various end uses such as a flocculant.

The present invention relates to the field of hyperbranched polyester amides with improved properties preferably suitable for use in one or more of certain end uses and/or applications as described herein.

In many types of industrial and/or domestic processes or applications polymeric materials are used that must remain in solution at elevated temperatures and/or in the presence of salts. Examples of such materials include flocculants used in paper production and dishwater detergents.

Water soluble polymers typically use in these applications are block copolymers of polyethylene glycol and polypropylene glycol, polyethoxylated alkylphenols, ethoxylated alkylphenol-formaldehyde resins, polyvinylalcohol derivatives and cationic or anionic polyelectrolytes.

However these water soluble polymers have certain disadvantages. They can be non-biodegradable, which hinders their use in certain areas such as wastewater treatment. A disadvantage of some phenolic polymers is their suspected interference with the human endocrine system. Other water soluble polymers are toxic against water organisms. Therefore there is a need for water soluble polymers that remain soluble at high temperature and/or high salt concentrations and don't have some or all of the disadvantages described herein.

Hyperbranched polyester amides are available commercially from DSM under the registered trade mark Hybrane® in a variety of different types that comprise different functional groups. Whilst many generic types of such hyperbranched polymers exist, they are not all suitable for all applications. It would be desirable to find hyperbranched polymers which are particularly suitable for some or all of the applications described herein.

Currently used hyperbranched polymers have a low cloud point and when experiencing high temperatures it has been found that such materials when added to liquid media (such as in aqueous dispersions) can show phase separation above their cloud point, resulting in sticky deposits and lower concentrations which are thus less effective in their end use even if they can be re-dissolved completely on cooling. Therefore it would be desirable to provide hyperbranched polymers with higher cloud points than those presently available. It has also surprisingly been found that the presence of certain salts in the mixture also has a large influence in lowering the cloud point with sulphate and carbonate ions having a significant influence.

Malcolm A. Kelland (J. App. Poly. Sci. 15 Aug. 2011 pp 2282-2290) reports preparing a certain hyperbranched polyester amides from diisopropanol amine and cyclic dicarboxylic anhydrides to study their lower critical solution temperatures (LCST) in water (measured as an optical cloud point). Kelland concludes that ‘polyester amides with low LCST are of interest for biological and medical applications whereas polyester amides with a high LCST values may be useful . . . for high salinity produced fluids . . . . ’ Despite this general statement the Kelland paper does not provide many details about which specific cloud point values may be advantageous in practise for which end uses of polyester amides and describes synthesis of only a few types of polyester amides which are then tested for only a limited number of end uses. So the conclusions in Kelland can be considered tentative and too vague to be of much practical assistance in developing or optimising polyester amide products for new and existing end uses. Kelland does not describe or prepare mixtures of combinations of polyester amides with different functional groups such as those described herein.

It is a preferred object of the invention to solve some or all of the problems identified herein and to provide improved polyester amides optimised for different uses as well as improved methods of preparing them.

Surprisingly the applicant has discovered that certain hyperbranched polyester amides having a cloud point value above a minimum value (as tested under the conditions defined herein) are especially useful in one or more of the end uses described herein (also referred to herein collectively as END USES), for example use as a flocculant.

Therefore broadly in accordance with the present invention there is provided a hyperbranched polyester amide having a cloud point of at least one of the values described herein (such as at least 50° C.) where the polyester amide comprises at least one end group thereon selected from two or more, preferably three or more most preferably four or more of any of the following end groups from types (i) to (iv)
i) tertiary amine functional end groups (also denoted herein as (t-amine or A groups)
ii) quaternary ammonium functional end groups (also denoted herein as quaternary (Q) or quaternary ammonium cation (QAC) groups) preferably comprising tertiary amine groups that are protonated;
iii) polyalkylene glycol functional end groups (also denoted herein as E groups), preferably polypropylene glycol and/or polyethylene glycol, more preferably polyethylene glycol groups (also denoted herein as EO groups); and
iv) neutral end groups comprising a positively charged cationic moiety preferably an onium ion (more preferably a quaternary ammonium or phosphonium cation) which bears no hydrogen atom covalently attached to a negatively charged moiety such as a carboxylate group which may not be adjacent to the cationic site;
v) additional polar (anionic) end groups such as phosphates; and/or
any mixtures and/or combinations of types (i) to (v) whether the end groups are on the same or different macromolecules that comprise the polyester amide.

Conveniently hyperbranched polyester amides of the invention comprise at least one end group from types (ii) to (iv), more conveniently comprise at least one end group from types (iii) and/or (iv).

Usefully the hyperbranched polyester amides of the invention (especially if they also contain cationic groups) may also comprise one or more anionic carboxylate counter ion(s) obtained and/or obtainable from at least one organic (mono or poly) carboxylic acid (including acidic and/or hydrogen salts thereof).

Preferred counter anions may be derived from organic carboxylic acids comprising:

C₆₋₂₂ linear carboxylic acids and acid salts thereof, more preferably C₆₋₂₀ mono-unsaturated, di unsaturated or saturated acids and acid salts thereof; even more preferably C₆₋₁₈ mono unsaturated or saturated acids and acid salts thereof; most preferably selected from: citric acid [HOC(CH₂COOH)₂COOH] acid salts of citric acid (such as choline dihydrogen citrate[2-(Hydroxyethyl)trimethylammonium citrate,]) gluconic acid [HOCH₂(CHOH)₄COOH], oleic acid [n-octadecan-9-enoic acid] and/or linoleic acid [n-octadecan-9,12-dienoic acid]; for example citric acid and acid salts thereof, citric acid being especially preferred.

Hyperbranched polyester amides of the present invention may be obtained and/or obtainable from an acid and/or aqueous acid mixture comprising at least 10%, preferably at least 15%, more preferably at least 20% by weight of any organic carboxylic acid(s) and/or mixtures thereof (e.g. any as described above) which may provide some or all of the counter anions to the cationic functional groups thereon.

As used herein (unless the context clearly indicates otherwise) the term organic carboxylic acid encompasses organic acids having one or a plurality of carboxy groups (COOH thereon) and all acid salts obtainable by partial neutralization of polyprotic carboxylic acids.

In accordance with another aspect of the present invention there is provided use as a flocculant of a hyperbranched polyester amide as described herein having a cloud point of at least one of the values described herein (such as at least 50° C.).

In accordance with yet another aspect of the present invention there is provided a method of flocculating a material dispersed in an aqueous medium comprising the steps of: providing an material dispersed in an aqueous medium and adding thereto a sufficient amounts of one or more of the hyperbranched polyester amide(s) as described herein having a cloud point of at least one of the values described herein (such as at least 50° C.) to cause the material dispersed in said medium to flocculate.

Hyperbranched polyester amides of the present invention have a cloud point of at least 50° C., conveniently at least 55° C., preferably at least 60° C., more preferably at least 80° C., most preferably at least 90° C., in particular at least 100° C. as measured in one or more of the tests described herein in demineralised water (DMW) and/or in salt solution (such as that described herein as BRINE). Conveniently polyester amides of the present invention have a cloud value of at least one of the previously described values in at least one of DMW and BRINE, more conveniently in BRINE, most conveniently in both DMW and BRINE.

Where the polyester amides of the invention are hyper-branched polymers they may be prepared by the methods described one or more of the publications below (and combinations thereof) and/or have structures as described thereto. The contents of these documents are incorporated by reference. It will be appreciated that the core structure of the polyester amide can be formed as described in any of the known ways described on the documents below that are otherwise consisted with the invention herein. The present invention relates to novel and improved polyester amides due to the nature of the end groups thereon and the core structure is less critical to the advantageous properties described herein.

In one embodiment of the invention the hyperbranched polyester amides may comprise, as a core structure, a moiety obtained or obtainable from polycondensation reaction between a one or more dialkanol amines and more or more cyclic anhydrides. Optionally further end groups may be attached to the core structure as described herein.

The cyclic anhydride used to prepare the hyperbranched polyester amides of the invention may comprise at least one of: succinic anhydride, C₁-C₁₈ alkylsuccinic anhydrides, C₁-C₁₈ alkenylsuccinic anhydrides, polyisobutenylsuccinic anhydride, phthalic anhydride, cyclohexyl-1,2-dicarboxylic anhydride, cyclohexen-3,4-yl-1,2-dicarboxylic anhydride and/or a mixture of two or more thereof.

Another aspect of the present invention provides a composition comprising a hyperbranched polyester amide of the invention as described herein together with a diluent, conveniently water. Preferably the polyester amide is present in the composition in an amount of from 0.1% to 50%, more preferably 0.1% to 10%, and most preferably 0.1% to 5% by weight percentage of the total composition.

Hyperbranched polymers are polymers, which contain a large number of branching sites. Compared to conventional linear polymers which only contain two end groups, hyperbranched polymers possess a large number of end groups, for example on average at least five end groups, preferably on average at least eight end groups per macromolecule. Hyperbranched polyester amides can be produced by polycondensation of dialkanol amines and cyclic anhydrides with optional modification of the end groups, as described in EP1036106, EP1306401, WO 00/58388, WO 00/56804 and/or WO07/098888.

The chemistry of the polyester amides allows the introduction of a variety of functionalities, which can be useful to give the polyester amides other additional properties. Preferred functional end groups comprise (for example are) —OH, —COOH, —NR₁R₂, where R₁ and R₂ can be the same or different C₁₋₂₂alkyl, —OOC—R or —COOR, where R is an alkyl or aralkyl group. Other possible end groups are derived from polymers, silicones or fluoropolymers. Still other end groups are derived from cyclic compounds, e.g. piperidine and/or derivatives thereof. Hyperbranched polyester amides with these functionalities may be produced by any suitable method. For example carboxy functional hyperbranched polyester amide polymers are described in WO 2000-056804. Dialkyl amide functional hyperbranched polyester amide polymers are described in WO 2000-058388. Ethoxy functional hyperbranched polyester amide polymers are described in WO 2003-037959. Hetero functionalised hyperbranched polyester amides are described in WO 2007-090009. Secondary amide hyperbranched polyester amides are described in WO 2007-144189. It is possible, and often even desirable, to combine a number of different end group functionalities in a single hyperbranched polyester amide molecule in order to obtain desirable properties of the polymer.

The properties of a hyperbranched polyester amide may be modified by selecting the cyclic anhydride used to build up the polymer structure. Preferred cyclic anhydrides are succinic anhydride, alkylsuccinic anhydrides (where the length of the alkyl chain can vary from C₁ to C₁₈), alkenylsuccinic anhydrides (where the length of the alkenyl chain can vary from C₁ to C₁₈), polyisobutenylsuccinic anhydride, phthalic anhydride, cyclohexyl-1,2-dicarboxylic anhydride, cyclohexen-3,4-yl-1,2-dicarboxylic anhydride and other cyclic anhydrides. Especially preferred are succinic anhydride and cyclohexyl-1,2-dicarboxylic anhydride. It is possible to combine more than one type of anhydride to produce a hyperbranched polyester amide with the desired additional properties.

Additionally the anhydride can be replaced by the corresponding dicarboxylic acid to obtain the same product as e.g. succinic anhydride can be partly replaced by succinic acid.

In one embodiment the polyester amides of the invention may be obtained by both a cyclic anhydride and a diacid used together in the same process. Preferably the diacid is derived from the cyclic anhydride. A preferred weight percentage for the amount of anhydride is from 1 to 99%, more preferably from 10 to 90%, most preferably from 20 to 80% with respect to the total weight of anhydride and diacid. A preferred weight percentage of diacid is from 1 to 99%, more preferably from 10 to 90%, most preferably from 20 to 80% with respect to the total weight of anhydride and diacid.

The structure and properties of the polyester amides can be varied over a broad range of polarities and interfacial properties. This makes the hyperbranched polyester amides applicable to solve a variety of problems where water soluble polymers are required at high temperature and/or brine.

A further aspect of the invention broadly provides a use of a polyester amide (preferably hyperbranched polyester amide) in any of the applications described herein (END USES) such as use as a flocculant for example to make paper.

Preferred end uses and/or applications where the polyester amides of the invention may be advantageous are one or more of the following: uses that require polyester amides to remain in solution at elevated temperatures and/or in the presence of salts, as for example applications in the presence of calcium carbonate formation; in geothermal wells for geothermal energy production, cooling towers, cooling water in industrial plants and/or heat exchangers; as flocculants, rheology modifiers and/or dispersants for solid particles in for example paper production, as detergents in for example dishwashers where higher temperature and salts are usually present; material engineering applications; chemical engineering, separation processes (such as extractive distillation, solvent extraction, absorption, membranes and/or chromatography), additives (such as for coatings and/or resins), biotechnical reactor-based processes, formation of functional and/or protective coatings, formation of coatings having low viscosity and/or rapid drying, formation of thin films and/or sensors, formation of nano-sized materials, decontamination and anti-fouling of surfaces, formation of bio-mimetic materials, and/or any suitable combinations of the aforegoing (collectively referred to herein as END USES). The polyester amides of the invention may also be useful in biological and/or medical applications (such as gene and/or drug delivery, biomaterials and/or biointeraction).

Hyperbranched polyester amides that may be used in the present invention are preferably water soluble and may be optionally soluble in most organic solvents. A further yet still other aspect of the invention broadly provides for use of polyester amide (preferably hyperbranched polyester amide) as described herein in any of the methods of the invention described herein.

The process of the present invention may use hyperbranched polyester amides alone or in combinations or formulations with other active ingredients as necessitated by specific applications. Examples of other compounds with specific activity are corrosion inhibitors, antifoaming agents, biocides, detergents, rheology modifiers and other functions as made necessary by the application. Application of the hyperbranched polyester amide in the process according to the invention may be as solid or liquid, or dissolved in a solvent which can be chosen by those skilled in the art.

Preferably the polyester amides and/or used in the present invention are substantially non-linear, non-cyclic branched macromolecules (such as polymers) having three or more polymeric centres, more preferably having a molecular weight of at least 100. Usefully the polyester amides are three dimensional hyperbranched polymers, star-shaped polymers or dendrimeric macro-molecules.

Suitable apolar groups (end groups) may be optionally substituted hydrocarbo groups comprising at least 4 carbon atoms.

Preferred polyester amides of and/or used in the present invention comprise those in which the (average) ratio of polar groups to apolar groups is from about 1.1 to about 20, more preferably from 1.2 to 10, most preferably from 1.5 to 8.0. These ratios may be weight ratios and/or molar ratios, preferably are weight ratios.

Hyperbranched polyester amides of and/or used in the present invention may obtained and/or obtainable from: at least one organo building block and at least one tri (or higher) organo valent branching unit, where the at least one building block is capable of reacting with the at least one branching unit; and at least one or the building block and/or the branching unit (conveniently the branching unit) comprises an end group comprising a polar moiety.

More preferred hyperbranched polyester amides of and/or used in the present invention may obtained and/or obtainable from: at least one building block comprising one or more polycarboxylic acid(s) and/or one or more anhydride(s) obtained and/or obtainable from one or more polycarboxylic acid(s); and at least one branching unit comprising at least one tri functional nitrogen atom where the at least one branching unit containing an end group comprising a polar moiety.

Suitable polycarboxylic acid(s) that may be used as and/or to prepare the building block(s) may conveniently be dicarboxylic acids such as C₂₋₁₂hydrocarbo dicarboxylic acids; more conveniently linear di-acids and/or cyclic di-acids; and most conveniently linear di-acids with terminal carboxylic acid groups such as those selected from the group consisting of: saturated di-acids such as: 2-ethanedioic acid (oxalic acid); 3-propanedioic acid (malonic acid); 4-butanedioic acid (succinic acid), 5-pentanedioic acid (glutaric acid); 6-hexanedioic acid (adipic acid); 7-heptanedioic acid (pimelic acid); 8-octanedioic acid (suberic acid); combinations thereof; and mixtures thereof; and unsaturated di-acids such as: Z-(cis)-butenedioic acid (maleic acid); E-(trans)-butenedioic acid (fumaric acid); 2,3-dihydroxybutandioic acid (tartaric acid); combinations thereof; and/or mixtures thereof.

Useful hyperbranched polyester amides of and/or used in the present invention may be obtained and/or obtainable from at least one building block that comprises: optionally substituted C₂₋₃₀hydrocarbo dioic acids and/or anhydrides thereof, combinations thereof on the same moiety; and/or mixtures thereof on different moieties;

More useful hyperbranched polyester amides of use in the present invention may obtained and/or obtainable from at least one building block that comprises: C₄₋₁₆alkenyl C₂₋₁₀dioic anhydrides; C₄₋₁₆cycloalkyl dicarboxylic acid anhydrides; C₂₋₁₀alkandioic anhydrides; phthalic anhydrides, combinations thereof on the same moiety and/or mixtures thereof on different moieties.

Most useful hyperbranched polyester amides of use in the present invention may obtained and/or obtainable from at least one building block that comprises: dodecenyl (i.e. C₁₂alkenyl) succinic (i.e. 4-butanedioic) anhydride; cyclohexane-1,2-dicarboxylic acid anhydride; succinic (i.e. 4-butanedioic) anhydride; combinations thereof on the same moiety; and/or mixtures thereof on different moieties.

Suitable branching units that may be used to prepare hyperbranched polyester amides of and/or used in the present invention may be any moiety capable of reacting with the building block and/or precursor therefor (such as any of those described herein) at three or more sites on the branching unit to form a three dimensional (branched) product. Branching units denote those units which form the core structure of the hyperbranched polyester amides and do not necessarily form end groups.

Branching units may comprise one or more polyoxyalkylene moiet(ies) comprises polyoxyalkylene repeat unit(s) for example suitable unsubstituted or substituted alkylene groups such as ethylene, propylene, butylene, and isobutylene. The polyoxyalkylene moiety comprising one or more of these repeat units can be a homo-, block or random polymer, or any suitable mixtures thereof. Preferred the average total number of repeat units in polyoxyalkylene moiet(ies) suitable for use in branching units herein is from 2 to 100, more preferably 5 to 60, most preferably 10 to 50, for example 16 or 45.

The end groups described herein may be selected from those described herein, such as two or more, preferably three or more, most preferably four or more of any of the following end groups from types (i) to (v):
i) tertiary amine functional end groups (also denoted herein as (t-amine or A groups)
ii) quaternary ammonium functional end groups (also denoted herein as Q groups) preferably comprising tertiary amine groups that are protonated and quaternary ammonium cations that have four hydrocarbo substituents (preferably together not forming a ring) attached to a positively charged nitrogen atom (also denoted herein as QAC) more preferably QAC groups,
iii) polyalkylene glycol functional end groups (also denoted herein as E groups), preferably polypropylene glycol and/or polyethylene glycol, more preferably polyethylene glycol groups (also denoted herein as EO groups);
iv) quaternary ammonium zwitterionic end groups, i.e. comprising zwitterions that have an anionic group (preferably carboxylate) attached to a positively charged nitrogen atom. More preferred neutral end groups (also denoted herein by the abbreviation BQ or betaine-type′ groups) are represented by the Formula 1:

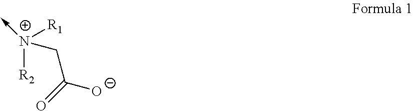

where R₁ and R₂ independently denote optionally substituted C₁₋₆hydrocarbo groups, preferably C₁₋₄hydrocarbyl groups, more preferably are both methyl (in which case Formula 1 represents a monovalent diimethylglycinyl group, also referred to herein as a ‘betaine’ group derived from N,N,N-trimethylglycine or glycine betaine); and
v) additional polar (anionic) end groups such as phosphates and the like; and/or any mixtures and/or combinations thereof whether on the same or different macromolecule that comprises the polydisperse polyester amide.

Useful non hydroxyl functional hyperbranched polyester amides of and/or used in the present invention may be obtained and/or obtainable from:

at least one building block selected from the group consisting of:
optionally substituted C₂₋₃₀hydrocarbo dioic acid,
anhydrides thereof;
combinations thereof on the same moiety; and
mixtures thereof on different moieties;

More useful hyperbranched polyester amides of use in the present invention may be obtained and/or obtainable from:

at least one building block selected from the group consisting of:
C₄₋₁₆alkenyl C₂₋₁₀dioic anhydride;
C₄₋₁₆cycloalkyl dicarboxylic acid anhydride;
C₂₋₁₀alkandioic anhydride;
combinations thereof on the same moiety; and
mixtures thereof on different moieties.

The at least one building blocks as described herein may comprises at least one end group selected from the group consisting of:
substituted nitrogen containing C₁₋₁₀hydrocarbo;
quaternised C₁₋₁₂hydrocarbo (e.g. C₁₋₆hydrocarbyl) substituted amino
poly(C₂₋₄alkyenyloxy)ₙ groups optionally terminated with an alkoxy group (e.g. C₁₋₄alkoxy) where optionally n is from 15 to 50;
quaternised carboxylate C₁₋₁₂hydrocarbo (e.g. C₁₋₆hydrocarbylcarboxylate) substituted amino
optionally quaternised C₁₋₁₂hydrocarbo (e.g. C₁₋₁₆hydrocarbyl) substituted amino optionally neutralised carboxylic acid groups;
optionally substituted nitrogen containing C₃₋₁₀ rings (such as morpholo); phosphates;
combinations thereof on the same moiety; and
mixtures thereof on different moieties.

Most useful functional hyperbranched polyester amides of use in the present invention may be obtained and/or obtainable from:

at least one building block selected from the group consisting of:
dodecenyl (i.e. C₁₂alkenyl) succinic (i.e. 4-butanedioic) anhydride;
cyclohexane-1,2-dicarboxylic acid anhydride;
succinic (i.e. 4-butanedioic) anhydride;
combinations thereof on the same moiety; and
mixtures thereof on different moieties;
   at least one branching unit selected from the group consisting of:
diisopropanol amine; diethanolamine;
trishydroxymethylene amino methane;
combinations thereof on the same moiety; and
mixtures thereof on different moieties;

Advantageously hyperbranched polyester amides of and/or used in the present invention may have a (theoretical) number average molecular weight (Mₙ) of from about 500 to about 50000 g/mol; more advantageously from about 800 to about 30000 g/mol; most advantageously from about 1000 to about 20000 g/mol; even more particularly from about 1200 to about 17000 g/mol.

The end group (or reagents and/or precursors therefore) may be introduced at any stage in the preparation of the polyester amide, though typically is introduced at the beginning. The end group may be attached at any point to the molecule.

Specific examples of typical idealized structure of particular preferred hyperbranched polyester amide of and/or used in the present invention are given below.

The terms ‘optional substituent’ and/or ‘optionally substituted’ as used herein (unless followed by a list of other substituents) signifies the one or more of following groups (or substitution by these groups): carboxy, sulfo, sulfonyl, phosphates, phosphonates, phosphines, formyl, hydroxy, amino, imino, nitrilo, mercapto, cyano, nitro, methyl, methoxy and/or combinations thereof. These optional groups include all chemically possible combinations in the same moiety of a plurality (preferably two) of the aforementioned groups (e.g. amino and sulfonyl if directly attached to each other represent a sulfamoyl group). Preferred optional substituents comprise: carboxy, sulfo, hydroxy, amino, mercapto, cyano, methyl, halo, trihalomethyl and/or methoxy, more preferred being methyl and/or cyano.

The synonymous terms ‘organic substituent’ and “organic group” as used herein (also abbreviated herein to “organo”) denote any univalent or multivalent moiety (optionally attached to one or more other moieties) which comprises one or more carbon atoms and optionally one or more other heteroatoms. Organic groups may comprise organoheteryl groups (also known as organoelement groups) which comprise univalent groups containing carbon, which are thus organic, but which have their free valence at an atom other than carbon (for example organothio groups). Organic groups may alternatively or additionally comprise organyl groups which comprise any organic substituent group, regardless of functional type, having one free valence at a carbon atom. Organic groups may also comprise heterocyclyl groups which comprise univalent groups formed by removing a hydrogen atom from any ring atom of a heterocyclic compound: (a cyclic compound having as ring members atoms of at least two different elements, in this case one being carbon). Preferably the non-carbon atoms in an organic group may be selected from: hydrogen, halo, phosphorus, nitrogen, oxygen, silicon and/or sulphur, more preferably from hydrogen, nitrogen, oxygen, phosphorus and/or sulphur.

Most preferred organic groups comprise one or more of the following carbon containing moieties: alkyl, alkoxy, alkanoyl, carboxy, carbonyl, formyl and/or combinations thereof; optionally in combination with one or more of the following heteroatom containing moieties: oxy, thio, sulfinyl, sulfonyl, amino, imino, nitrilo and/or combinations thereof. Organic groups include all chemically possible combinations in the same moiety of a plurality (preferably two) of the aforementioned carbon containing and/or heteroatom moieties (e.g. alkoxy and carbonyl if directly attached to each other represent an alkoxycarbonyl group).

The term ‘hydrocarbo group’ as used herein is a sub set of an organic group and denotes any univalent or multivalent moiety (optionally attached to one or more other moieties) which consists of one or more hydrogen atoms and one or more carbon atoms and may comprise one or more saturated, unsaturated and/or aromatic moieties. Hydrocarbo groups may comprise one or more of the following groups. Hydrocarbyl groups comprise univalent groups formed by removing a hydrogen atom from a hydrocarbon (for example alkyl). Hydrocarbylene groups comprise divalent groups formed by removing two hydrogen atoms from a hydrocarbon, the free valencies of which are not engaged in a double bond (for example alkylene). Hydrocarbylidene groups comprise divalent groups (which may be represented by “R₂C═”) formed by removing two hydrogen atoms from the same carbon atom of a hydrocarbon, the free valencies of which are engaged in a double bond (for example alkylidene). Hydrocarbylidyne groups comprise trivalent groups (which may be represented by “RC≡”), formed by removing three hydrogen atoms from the same carbon atom of a hydrocarbon the free valencies of which are engaged in a triple bond (for example alkylidyne). Hydrocarbo groups may also comprise saturated carbon to carbon single bonds (e.g. in alkyl groups); unsaturated double and/or triple carbon to carbon bonds (e.g. in respectively alkenyl and alkynyl groups); aromatic groups (e.g. in aryl groups) and/or combinations thereof within the same moiety and where indicated may be substituted with other functional groups

The term ‘alkyl’ or its equivalent (e.g. ‘alk’) as used herein may be readily replaced, where appropriate and unless the context clearly indicates otherwise, by terms encompassing any other hydrocarbo group such as those described herein (e.g. comprising double bonds, triple bonds, aromatic moieties (such as respectively alkenyl, alkynyl and/or aryl) and/or combinations thereof (e.g. aralkyl) as well as any multivalent hydrocarbo species linking two or more moieties (such as bivalent hydrocarbylene radicals e.g. alkylene).

Any radical group or moiety mentioned herein (e.g. as a substituent) may be a multivalent or a monovalent radical unless otherwise stated or the context clearly indicates otherwise (e.g. a bivalent hydrocarbylene moiety linking two other moieties). However where indicated herein such monovalent or multivalent groups may still also comprise optional substituents. A group which comprises a chain of three or more atoms signifies a group in which the chain wholly or in part may be linear, branched and/or form a ring (including spiro and/or fused rings). The total number of certain atoms is specified for certain substituents for example C_{1-N}organo, signifies an organo moiety comprising from 1 to N carbon atoms. In any of the formulae herein if one or more substituents are not indicated as attached to any particular atom in a moiety (e.g. on a particular position along a chain and/or ring) the substituent may replace any H and/or may be located at any available position on the moiety which is chemically suitable and/or effective.

Preferably any of the organo groups listed herein comprise from 1 to 36 carbon atoms, more preferably from 1 to 18. It is particularly preferred that the number of carbon atoms in an organo group is from to 12, especially from 1 to 10 inclusive, for example from 1 to 4 carbon atoms.

As used herein chemical terms (other than IUAPC names for specifically identified compounds) which comprise features which are given in parentheses—such as (alkyl)acrylate, (meth)acrylate and/or (co)polymer denote that that part in parentheses is optional as the context dictates, so for example the term (meth)acrylate denotes both methacrylate and acrylate.

Certain moieties, species, groups, repeat units, compounds, oligomers, polymers, materials, mixtures, compositions and/or formulations which comprise and/or are used in some or all of the invention as described herein may exist as one or more different forms such as any of those in the following non exhaustive list: stereoisomers (such as enantiomers (e.g. E and/or Z forms), diastereoisomers and/or geometric isomers); tautomers (e.g. keto and/or enol forms), conformers, salts, zwitterions, complexes (such as chelates, clathrates, crown compounds, cyptands/cryptades, inclusion compounds, intercalation compounds, interstitial compounds, ligand complexes, organometallic complexes, non-stoichiometric complexes, π adducts, solvates and/or hydrates); isotopically substituted forms, polymeric configurations [such as homo or copolymers, random, graft and/or block polymers, linear and/or branched polymers (e.g. star and/or side branched), cross linked and/or networked polymers, polymers obtainable from di and/or tri valent repeat units, mono-disperse dendrimers (unless the context herein clearly indicates otherwise), polymers of different tacticity (e.g. isotactic, syndiotactic or atactic polymers)]; polymorphs (such as interstitial forms, crystalline forms and/or amorphous forms), different phases, solid solutions; and/or combinations thereof and/or mixtures thereof where possible. The present invention comprises and/or uses all such forms which are effective as defined herein.

Polyester amides may also usefully exhibit other properties to be useful in one or more of the end uses and/or applications described herein. For example the polyester amides may exhibit at least one of those desired properties described herein and/or any combinations thereof that are not mutually exclusive.

Useful polyester amide(s) may exhibit one or more improved propert(ies) (such as those described herein) with respect to known polyester amides. More usefully such improved properties may be in a plurality, most usefully three or more of those properties below that are not mutually exclusive.

Conveniently the polyester amide(s) may exhibit one or more comparable propert(ies) (such as those described herein) with respect to known polyester amides. More usefully such comparable properties may be in two or more, most usefully three or more, for example all of those properties below that are not improved and/or mutually exclusive.

Improved propert(ies) as used herein denotes that the value of one or more parameter(s) of the polyester amides of the present invention is >+8% of the value of that parameter for the reference described herein, more preferably >+10%, even more preferably >+12%, most preferably >+15%.

Comparable properties as used herein means the value of one or more parameter(s) of the polyester amides of the present invention is within +/−6% of the value of that parameter for the reference described herein, more preferably +/−5%, most preferably +/−4%.

The known reference polyester amide for these comparisons is comparative example COMP 1′ (prepared as described herein) used in the same amounts (and where appropriate in the same compositions and tested under the same conditions) as polyester amides of the invention being compared.

The percentage differences for improved and comparable properties herein refer to fractional differences between the polyester amide of the invention and the comparative example COMP 1′ (prepared as described herein) where the property is measured in the same units in the same way (i.e. if the value to be compared is also measured as a percentage it does not denote an absolute difference).

It is preferred that polyester amides of the invention (more preferably hyperbranched polyester amides) have improved have improved utility in one or more of the END USES described herein (measured by any suitable parameter known to those skilled in the art) compared to the comparative example COMP 1′ (prepared as described herein).

Many other variations embodiments of the invention will be apparent to those skilled in the art and such variations are contemplated within the broad scope of the present invention.

Further aspects of the invention and preferred features thereof are given in the claims herein.

### Test Methods

### Method to Determine Cloud Point

For determining the cloud point of the polyester amides the following procedure was followed.

In a 50 ml glass vial was weighted 140 mg of the polymer to which was added water or a brine solution to a total weight of 20 g In the case of amine containing polyester amides the pH was adjusted with 5 t % w/w HCl solution to the desired pH value. A Teflon coated stirrer bar was added to the vial and a thermocouple was immersed in the solution for at least 1 cm, approximately in the middle of the vial. The vial was placed on a stirrer/heater and the temperature was gradually increased while stirring. The solution was observed visually while warming and the cloud point was indicated by the first sign of cloudiness of the solution.

### Composition Salt Solution (Also Referred to Herein as BRINE)

For the determination of the cloud point in brine solutions the following salt composition was made.

| | |
|---|---|
| 140 g | Sodium chloride |
| 30 g | Calcium chloride•6H₂O |
| 8 g | Magnesium chloride•6H₂O |

The salts were dissolved in 1 litre of demineralised water. The pH of the solution was adjusted to 4 (or another desired pH as specified) with 0.1 M hydrochloric acid solution.

### EXAMPLES

The present invention will now be described in detail with reference to the following non limiting examples which are by way of illustration only. These examples are highly branched polyester-amides containing a combination of at least two, preferably three, more preferably four of t-amine (also denote as A), quaternary (also denote as Q) polyethylene oxide (also denoted as EO) and/or betaine (also denoted as BQ) functional end groups. Such hyperbranched polyester amides are also referred to herein combo-functional hyperbranched polyester amides and include combinations with other functional end groups other than amine (A), ammonium (Q), alkoxy (EO) and/or betaine-type (BQ).

### Examples 1 to 4

Preparation of highly branched polyester amides containing tert amine and polyethylene glycol end groups

### Example 1

A double walled glass reactor, which can be heated by means of thermal oil, fitted with a mechanical stirrer, a distillation head, a vacuum and nitrogen connection was heated to 60° C. The reactor is charged with 209.2 g of hexahydrophthalic anhydride and 462.5 g of polyethylene glycol monomethyl ether with average molecular weight of 750 was added. The temperature was increased to 120° C. and the reaction mixture was stirred for 45 minutes. 46.1 g of N,N-bis(N′N′-dimethylaminopropyl)amine and 82.1 g of diisopropanol amine were added and the temperature was further increased to 180° C. After approximately 1 hour the pressure was gradually reduced to a final pressure of <10 mbar to distil off reaction water. Heating and vacuum were maintained until the residual carboxylic acid content was <0.3 meq/g (tritrimetrical analysis) to obtain, as a product, Example 1 which was characterised as follows:

AV=12.4 mgKOH/g. Amine content=0.52 meq/g (tritrimetrical analysis). Molecular weight Mn=6290

### Example 2

An analogous procedure was followed to that described in Example 1 using the following amounts of starting materials: 194.5 g of hexahydrophthalic anhydride, 480.6 g of polyethylene glycol monomethyl ether with average molecular weight of 1000, 44.9 g of N,N-bis(N′N′-dimethylaminopropyl)amine and 80.0 g of diisopropanol amine to obtain, as a product, Example 2 which was characterised as follows:

AV=5.0 mgKOH/g, amine content=0.52 meq/g. Molecular weight Mn=13000

### Example 3

An analogous procedure was followed to that described in Example 1 using the following amounts of starting materials: 194.2 g of hexahydrophthalic anhydride, 449.8 g of polyethylene glycol monomethyl ether with average molecular weight of 1000, 84.1 g of N,N-bis(N′N′-dimethylaminopropyl)amine and 71.9 g of diisopropanol amine to obtain, as a product, Example 3 which was characterised as follows:

AV=6.7 mg KOH/g, amine content=0.52 meq/g. I Molecular weight Mn=4320

### Example 4

An analogous procedure was followed to that described in Example 1 using the following amounts of starting materials: 311.1 g of dodecenylsuccinic anhydride instead of hexahydrophthalic anhydride, 238.8 g of polyethylene glycol monomethyl ether with average molecular weight of 750, 79.4 g of N,N-bis(N′N′-dimethylaminopropyl)amine and 70.7 g of diisopropanol amine to obtain, as a product, Example 4 which was characterised as follows:

AV=7.5 mg KOH/g, amine content=1.16 meq/g. Molecular weight Mn=6300

### Examples 5 and 6

Preparation of highly branched polyester amides containing amine, cyclic amides and polyethylene glycol end groups.

### Example 5

A double walled glass reactor, which can be heated by means of thermal oil, fitted with a mechanical stirrer, a distillation head, a vacuum and nitrogen connection was heated to 60° C. The reactor is charged with 172.9 g of hexahydrophthalic anhydride. 38.2 g of N,N-bis(N′N′-dimethylaminopropyl)amine and 26.6 g of morpholine and 394.4 g of polyethylene glycol monomethyl ether with average molecular weight of 2000 were added. The reaction mixtures was stirred for 1 hour at 60° C. after which the temperature was raised to 120° C. 67.9 g of diisopropanol amine was added. The reaction mixture was stirred for 1 hour after which the further increased to 180° C. After approximately 1 hour the pressure was gradually reduced to a final pressure of <10 mbar to distil off reaction water. Heating and vacuum were maintained until the residual carboxylic acid content was <0.3 meq/g (tritrimetrical analysis) to obtain, as a product, Example 5 which was characterised as follows:

.AV=15.0 mgKOH/g. Amine content=0.52 meq/g (tritrimetrical analysis). Molecular weight Mn=6670

### Example 6

An analogous procedure was followed to that described in Example 5 using the following amounts of starting materials: 132.3 g of hexahydrophthalic anhydride, 474.4 g of polyethylene glycol monomethyl ether with average molecular weight of 2000, 22.9 g of N,N-bis(N′N′-dimethylaminopropyl)amine, 21.4 g of morpholine and 49.0 g of diisopropanol amine to obtain, as a product, Example 6 which was characterised as follows: AV=4.6 mgKOH/g, amine content=0.41 meq/g. Molecular weight Mn=5580

### Examples 7 to 10

Preparation of highly branched polyester amides containing polyethylene glycol and betaïne functional end groups and optionally other end groups.

### Example 7

The product obtained in Example 1 (175 g) was dissolved in 175 g of water. 36.2 sodium chloroacetate and 36.2 g of water were added. The reaction mixture was stirred at 80° C. until ¹H-NMR analysis shows a complete conversion of the chloroacetate to obtain as product, Example 7.

### Example 8

An analogous procedure was followed to that described in Example 7 using the product obtained in example 2 to obtain as product, Example 8.

### Example 9

An analogous procedure was followed to that described in Example 7 using the product obtained in example 5 to obtain as product, Example 9.

### Example 10

An analogous procedure was followed to that described in Example 7 using the product obtained in Example 6 to obtain as product, Example 10.

TABLE 1
Cloud points

| Cloud point (° C.) | |
|---|---|
| DMW | BRINE |

| Example | pH = 4 | pH = 9 | pH = 4 | pH = 9 |
|---|---|---|---|---|
| Ex 1 | 93 | | 49 | |
| Ex 2 | >100 | 85 | 59 | 49 |
| Ex 3 | >100 | 73 | 63 | 47 |
| Ex 4 | >100 | | 55 | |
| Ex 5 | >100 | | 61 | |
| Ex 6 | >100 | | 60 | |
| Ex 7 | 95 | | 54 | |
| Ex 8 | >100 | | 60 | |
| Ex 9 | >100 | | 61 | |
| Ex 10 | >100 | | 58 | |

### COMPARATIVE EXAMPLES

Preparation of highly branched polyester amides containing hydroxy end groups.

### Comp 1′

A double walled glass reactor, which can be heated by means of thermal oil, fitted with a mechanical stirrer, a distillation head, a vacuum and nitrogen connection, is charged with 192.5 g of succinic anhydride. The reactor was heated to 125° C. When the succinic anhydride has melted 307.5 g of diisopropanol amine was added. The reaction mixture was stirred for 1 hour and then the temperature was raised to 160° C. Over a period of 4 hours the pressure was gradually reduce to a final pressure of <10 mbar to distil off reaction water. Heating and vacuum were maintained until the residual carboxylic acid content was <0.2 meq/g (tritrimetrical analysis). Molecular weight Mn=1200.

AV=5.2 mgKOH/g

### Comp 2′

A double walled glass reactor, which can be heated by means of thermal oil, fitted with a mechanical stirrer, a distillation head, a vacuum and nitrogen connection, is charged with 245.5 g of hexahydrophthalic anhydride. The reactor was heated to 80° C. When the anhydride has melted 254.5 g of diisopropanol amine was added. The reaction mixture was stirred for 1 hour and then the temperature was raised to 160° C. Over a period of 4 hours the pressure was gradually reduce to a final pressure of <10 mbar to distil off reaction water. Heating and vacuum were maintained until the residual carboxylic acid content was <0.2 meq/g (tritrimetrical analysis). Molecular weight Mn=1500. AV=6.4 mgKOH/g

TABLE 2
Comparative examples - cloud points

Cloud point (° C.)

| | DMW | BRINE |
|---|---|---|
| Example | pH = 4 | pH = 4 |
| Comp 1′ | 84 | 14 |
| Comp 2′ | insoluble | insoluble |

1. A hyperbranched polyester amide having a cloud point of at least 50° C. in BBRINE where the polyester amide comprises at least one end group thereon selected from:
two or more:
i) non-cyclic tertiary amine functional end groups
ii) quaternary ammonium functional end groups,
iii) polyalkylene glycol functional end groups;
iv) quaternary ammonium zwitterionic end groups, and/or
v) phosphate end groups

2. A hyperbranched polyester amide as claimed in claim 1, which has a cloud point of at least 60° C. in BRINE at pH 4 and where the at least one end group thereon comprises:
two or more of:
tertiary amine functional end groups substituted by C₁₋₆alkyl
tertiary amine groups that are protonated
polypropylene glycol and/or polyethylene glycol
zwitterions that have an anionic carboxylate attached to a positively charged nitrogen atom

3. A hyperbranched polyester amide as claimed in any preceding claim, which has a cloud point of at least 70° C. in BRINE and where the at least one end group comprises
two or more
tertiary amine functional end groups substituted by C₁₋₄alkyl
tertiary amine groups that are protonated
polyethylene glycol groups (EO groups)
betaïne-type functional end groups represented by Formula 1: 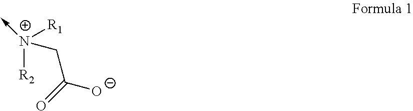
where R₁ and R₂ independently denote optionally substituted C₁₋₆hydrocarbo groups, preferably C₁₋₄hydrocarbyl groups, more preferably are both methyl.

4. A hyperbranched polyester amide as claimed in any preceding claim, which comprises cationic functional groups thereon and one or more carboxylate counter anion(s) obtained and/or obtainable from at least one organic (mono or poly) carboxylic acid (including acidic and/or hydrogen salts thereof).

5. A hyperbranched polyester amide as claimed in the preceding claim which comprises one or more carboxylate counter ion(s) obtained and/or obtainable from citric acid and/or any suitable acid salt thereof.

6. A hyperbranched polyester amide as claimed in any preceding claim comprising a core obtained and/or obtainable from hexahydrophthalic anhydride.

7. A hyperbranched polyester amide as claimed in any preceding claim, which has a cloud point of at least 100° C. in BRINE.

8. A hyperbranched polyester amide as claimed in any preceding claim comprising a core obtained and/or obtainable from at least one hexahydrophthalic anhydride, at least one cationic end group and at least one citrate counter anion, where the polyester amide has a cloud point of at least 100° C. in BRINE.

9. A composition suitable for use as a flocculant comprising a hyperbranched polyester amide as claimed in any of claims 1 to 8 and a suitable diluent.

10. Use as a flocculant of a polyester amide as claimed in any of claims 1 to 8 and/or a composition as claimed in claim 9.

11. A method of flocculating a material dispersed in an aqueous medium comprising the steps of: providing an material dispersed in an aqueous medium and adding thereto a sufficient amounts of one or more polyester amide as claimed in any of claims 1 to 8 and/or a composition as claimed in claim 9 to cause the material dispersed in said medium to flocculate.
